(19) United States
(12) Patent Application Publication
(10) Pub. No.: US 2004/0113095 A1
(43) Pub. Date: Jun. 17, 2004

(54) Device for observation of samples by fluorescence particularly sequentially

(76) Inventors: Philippe Peltie, Saint-Paul de Varces (FR); Dominique Derou-Madeline, Yquelon (FR); Raymond Campagnolo, Grenoble (FR)

Correspondence Address: Thelen Reid & Priest, PO Box 640640, San Jose, CA, 95164-0640, US

(21) Appl. No.: 10/467,777

(22) PCT Filed: Feb. 5, 2002
(86) PCT No.: PCT/FR02/00435

(30) Foreign Application Priority Data
Feb. 9, 2001 (FR) 01/01792

(51) Int. Cl. G01N 21/64

(52) U.S. Cl. 250/458.1

(57) ABSTRACT

Device for observation of samples by fluorescence, particularly sequentially.

To observe at least one sample (2), such as a biological sample, placed on a support (6), the device comprises at least a light source (42) to illuminate the sample, means (48) of reflecting this light towards the sample, a catadioptric objective (38) to observe an image of the sample, and means (52) of acquiring this image. The reflection means are placed between the objective and the support.

### CROSS-REFERENCE TO RELATED APPLICATION

This application claims priority based on International Patent Application No. PCT/FR02/00435, entitled “Device For Observation of Samples By Fluorescence, particularly Sequentially” by Philippe Peltie, Dominique Derou-Madeline and Raymond Campagnolo, which claims priority of French application no. 01/01792, filed on Feb. 9, 2001 which was not published in English.

### TECHNICAL FIELD

This invention relates to a device for observation of samples by fluorescence, particularly sequentially.

In particular, it is applicable to the analysis of the fluorescence of biological samples deposited on a support, in patterns at a uniform spacing from each other.

This support may for example be a microtiter plate having wells at the bottom of which biological samples are placed.

One particularly important application of the invention relates to the high flow cellular analysis in which cells marked by a fluorophore are deposited at the bottom of the wells in a microtiter plate, for example containing 96 or 384 wells.

Images of the cells are then formed by observing the wells one after the other. These images are memorised and are then treated sequentially.

The purpose of the invention is particularly to analyse this type of plate at high speed, the analysis time for each well being of the order of 1 to 2 seconds, thus completing cellular instrumentation that frequently uses cytometres.

However, these cytometres are limited to the analysis of cells in suspension in a fluid and usually only a low reading rate is possible.

Another application of the invention consists of forming low complexity biochip images starting from the fluorescence of these biochips, each of them being placed at the bottom of a well in a microtiter plate, for example comprising 96 wells.

It is then useful to use a large number (several tens) of MICAM (Registered Trademark) type biochips comprising 128 electrodes, and to correlate the results obtained for these chips, for example when the expression of genes is being studied.

The plate supporting the biochips may be provided with various devices, for example fluid circulation means or temperature monitoring means.

### STATE OF PRIOR ART

A sequential sample observation device is already known. It consists of a microscope with epi-illumination and fluorescence provided with a camera.

This microscope comprises a motor driven base plate capable of moving a microtiter plate to illuminate the wells one after the other and thus acquire images of these wells one after the other.

An inverted microscope is frequently used to form the image of the bottom of each well.

This known device is commercially available from the Cellomics Inc. Company.

It usually uses a source of white light using a mercury or xenon lamp for the illumination of samples contained in the wells.

This type of light source has a broad spectrum, but its life does not exceed 200 to 300 hours.

When conventional fluorescent markers such as fluorescein, rhodamines or cynanines are available, it is preferable to use low power lasers of the order of 10 mW to 50 mW, which have a life of more than 2000 hours.

FIG. 1 diagrammatically illustrates an example of a known device of this type to be used for the observation of samples 2 placed in wells 4 of a microtiter plate 6, for which the bottom 8 and the walls 10 delimiting the wells can be seen.

The samples are excited by radiation 12 output from a laser 14 and produce fluorescence radiation 16 after this excitation.

The bottom of the microtiter plate is transparent to light output from the laser and to this fluorescence radiation.

Light output from the laser is shaped by means of an appropriate lens 18 and is then filtered by an appropriate filter 20.

The light thus filtered is reflected by means of a dichroic mirror 22 towards the microscope objective 24. It passes through this objective 24 that focuses it onto the sample being studied. Note that the samples are studied one after the other, the microtiter plate being placed on appropriate displacement means, not shown, for this purpose.

FIG. 1 also shows a camera 26 designed to pick-up the image of the sample being studied, due to fluorescence radiation 16 emitted by this sample.

This fluorescence radiation 16 also passes through the microscope objective 24 and then the dichroic mirror 22 (which is capable of reflecting radiation 12 and transmitting radiation 16) and reaches the camera 26 after passing through another filter 28 designed to eliminate any light from the laser that also reaches this camera.

Note that the dichroic mirror has to be used to separate radiations 12 and 16 (for example with wave lengths of 488 nm and 520 nm respectively) due to the existence of a common path for these radiations.

Note also that the filter is not perfect, so that a small quantity of parasitic light always reaches the camera.

Devices called “fluorimetres” are also known. These devices use either lasers or wide spectrum lamps that are filtered. But these fluorimetres use a photomultiplier to detect total emission of fluorescence from a well being studied. Consequently, they do not supply any image and therefore cannot be used if images are required.

### PRESENTATION OF THE INVENTION

The purpose of this invention is a device for observation of samples by fluorescence, which is faster and simpler than the known device shown in FIG. 1.

For example, a device conform with the invention is capable of forming 384 fluorescence images in about 10 minutes.

More specifically, the purpose of this invention is a device for observation by fluorescence of at least one sample placed on a support, this device comprising:

means of illuminating the sample, these illumination means comprising at least one light source,

an objective for observation of the sample along an observation axis, this observation objective being designed to form an image of the sample when the sample is illuminated,

means of relative displacement of the support with respect to the observation objective, to place the sample on the observation axis, and

means of acquisition of the image formed by the observation objective,

this device being characterised in that the observation objective is a catadioptric objective and in that the illumination means also comprise means of reflecting light output from the source to the sample, these reflection means being placed between the observation objective and the support.

According to one preferred embodiment of the device according to the invention, the catadioptric objective comprises:

a parabolic mirror designed to pick-up and then reflect light emitted by the sample when the sample receives light emitted by the source, and

an auxiliary mirror that is placed at the focus of the parabolic mirror and is designed to pick-up light reflected by this parabolic mirror and reflect this light to acquisition means,

the means of reflecting the light supplied by the source being placed between the auxiliary mirror and the support.

Preferably, the illumination means also comprise means of formatting the light emitted by the source.

This source is preferably a laser.

According to one particular embodiment of the device according to the invention, the illumination means comprise a plurality of sources capable of emitting different wave lengths of light, and means of activating any one of these sources.

The acquisition means may include a charge-coupled device (CCD) camera.

Preferably, the device according to the invention also comprises filter means placed between the catadioptric objective and the acquisition means and designed to allow only light emitted by the sample to pass when said sample is illuminated.

In one particular embodiment of the invention, a support capable of receiving a plurality of samples is used with means of relative displacement to place these samples on the observation axis one after the other, so that these samples can be observed sequentially.

For example, this support may be a microtiter plate comprising a plurality of wells in which the samples are respectively placed.

In this case, the device may also include means of automatically positioning wells on the observation axis.

These positioning means may for example include a photodiode with four quadrants.

The device according to the invention may also include means of processing each image acquired by the acquisition means.

If the support is a microtiter plate, the process preferably includes an image segmentation step and a step to calculate parameters for each well.

### BRIEF DESCRIPTION OF THE DRAWINGS

This invention will be better understood after reading the following description of example embodiments, that are given for information purposes only and are in no way limitative, with reference to the appended drawings, wherein:

FIG. 1 is a diagrammatic view of a known device for observation of samples, which has already been described,

FIG. 2 is a diagrammatic perspective view of a particular embodiment of the device according to the invention,

FIG. 3 is a diagrammatic view of different optical means included in the device in FIG. 2,

FIG. 4 diagrammatically and partially illustrates another device according to the invention, using lasers with different wave lengths, and

FIG. 5 is a diagrammatic and partial view of another device according to the invention, using a photodiode with four quadrants.

### DETAILED PRESENTATION OF PARTICULAR EMBODIMENTS

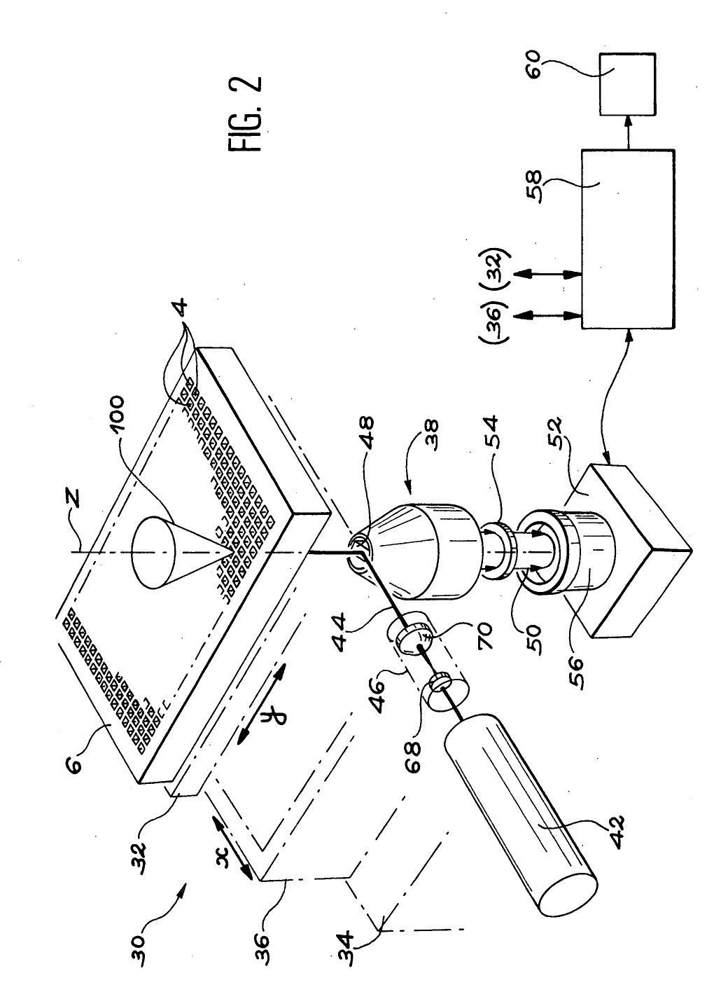

We will now describe an example of a device according to the invention with reference to FIGS. 2 and 3.

The device that can be seen in these figures is intended for observation of samples 2 contained in the wells 4 of the microtiter plate 6.

This device comprises an inverted microscope 30 equipped for epi-illumination.

The microtiter plate 6 may for example comprise 384 wells. This plate is held horizontally on a plate mobile frame 32 that is free to move with respect to the fixed frame 34 of the inverted microscope.

This is done by providing a base plate 36 that can be moved in translation with respect to the fixed frame of the microscope 34 along a horizontal direction x, and the plate mobile frame 32 also forms a base plate free to move in translation with respect to the base plate 36, along another horizontal direction y perpendicular to the x direction.

The device shown in FIGS. 2 and 3 also comprises a microscope lens forming a catadioptric objective 38 also called “reflection objective”. This catadioptric objective is supported by the turret (not shown) that is fitted on the microscope fixed frame 34.

The device also comprises an excitation laser 42 designed to emit radiation 44 that will excite the sample 2 being observed.

Note that the samples are studied one after the other by means of appropriate displacements of the mobile frame 32 and the base plate 36 along the x and y directions.

As it exits from the laser, this excitation radiation 44 is shaped using an optical shaping assembly 46. It is then reflected through a mirror 48 to the well 4 in which the sample 2 to be studied is located.

The excitation radiation reflected by the mirror is propagated along the vertical Z axis of the catadioptric objective 38, this axis forming the optical axis of the microscope.

Note that as a result of appropriate displacements along the x and y directions, the well containing the sample to be studied is located on this optical z axis.

The sample thus excited emits fluorescence radiation 50 that propagates along the z axis and is transferred through the catadioptric objective 38 to a camera 52 included in the device, after being filtered by a filter 54 designed to only allow fluorescence radiation 50 to pass.

For example, the magnification of the catadioptric objective 48 is of the order of 4 to 15 and the camera 52 is a CCD type camera cooled by appropriate means (not shown).

FIGS. 2 and 3 show the field reduction extension ring 56 fitted on the camera 52, and which is located on the input side of the camera.

The device in FIGS. 2 and 3 also comprises electronic processing means 58 (computer) designed to process images output by the camera 52 and also to control the camera and displacements along the x and y directions.

The computer 58 is provided with a video monitor 60 that is used in particular to observe images acquired using this camera 52.

A single laser is used in the example in FIGS. 2 and 3, but as will be seen better later, several lasers can be used if several markers that require several excitation wavelengths are used.

Furthermore, in this example, the base plates used are capable of high precision translations, but it is known that this type of base plate is slow.

As will be seen later, the cost of the device can be minimised by using less precise but much faster translation base plates, therefore resulting in a much faster device, provided that they are used with automatic well positioning means for positioning wells on the Z axis automatically one after the other.

Concerning the camera 58 used in the device in FIGS. 2 and 3, a camera containing for example 1300×1020 pixels may be used, with a size varying from 6.5 mm×6.5 mm to 10 mm×10 mm, and being cooled to 0° C. This gives a resolution of better than 3 μm to form the image of a 3 mm well.

Therefore, it is possible to work with a magnification of 4×—0.5 (0.5 corresponding to the field reduction extension ring placed in front of the camera) for a small camera (6.5 mm) or with a magnification of 15×—0.25 for a large camera.

Concerning the excitation of samples, the catadioptric objective 38 used comprises a parabolic mirror 62 and a small mirror 64. The reflecting face of this mirror 64 faces towards mirror 62 and the mirror 64 is placed at the focus of this mirror 62.

The mirror 48 that will reflect radiation emitted by the laser is a small mirror which is approximately the same size as the mirror 64 and is fixed to this mirror 64 and above it, so that it is located between the plate 6 and the mirror 64.

Radiation emitted by the laser 42 along a horizontal direction is reflected by the mirror 48 along the optical Z axis towards the sample being studied. This sample is then excited and emits fluorescence radiation 50.

This fluorescence radiation is picked up by the mirror 62 and is reflected towards the mirror 64 that in turn reflects this radiation along the optical Z axis towards the camera 52, through the filter 54.

Note that the parabolic mirror 62, which has its axis along the Z axis, is provided with a central hole 66 through which this optical Z axis passes to enable the fluorescence radiation 50 reflected by the mirror 64 to pass through.

Therefore, one important characteristic of the device in FIGS. 2 and 3 lies in the fact that the light beam emitted by the laser is located outside the optical path in the microscope. This laser beam does not pass through the catadioptric objective.

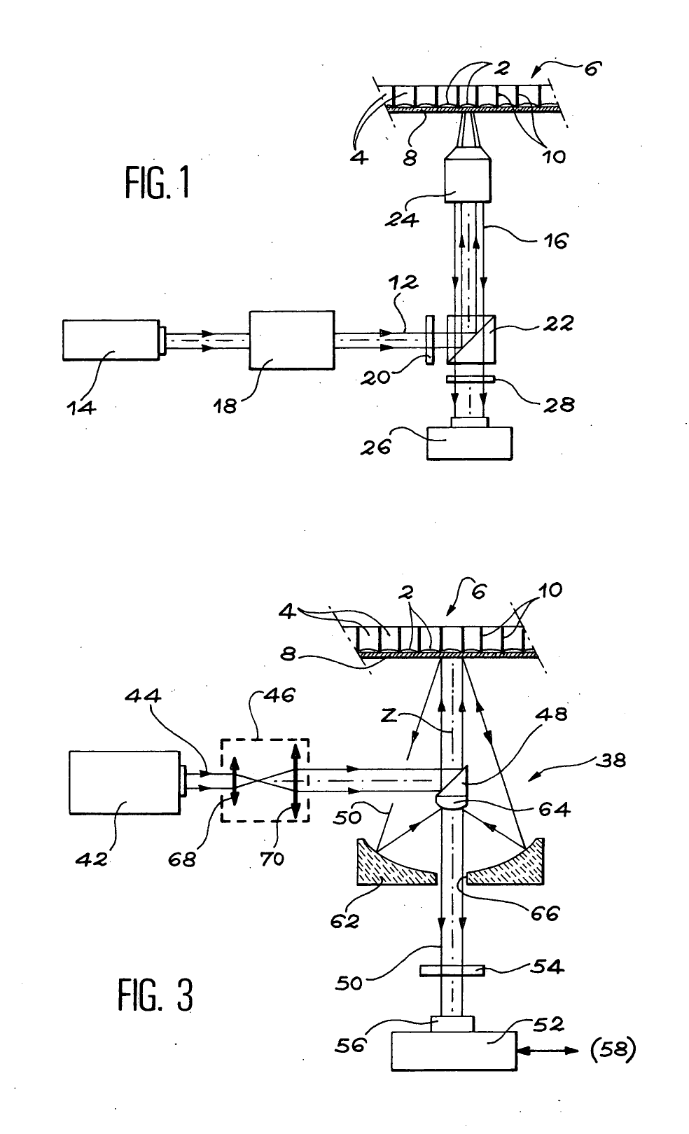

Therefore, the beam emitted by the laser is not mixed with the fluorescence radiation. Consequently, the device obtained is simpler than the device shown in FIG. 1.

The device in FIGS. 2 and 3 only requires a filter designed to eliminate parasite light that might be mixed with fluorescence light.

Furthermore, shaping of the beam emitted by the laser, or the excitation beam, is simpler than in the device in FIG. 1, since it is not focused by the microscope objective.

Furthermore, since the laser beam is located outside the optical path in the microscope, there is no need for a dichroic mirror to separate the laser excitation beam from the fluorescent beam emitted by the sample being studied. A single stop filter (cutting off the exciting wave length) is sufficient.

The optical shaping assembly 46 of the beam 44 emitted by the laser comprises two successive lenses 68 and 70 designed to magnify the beam emitted by the laser at least three times, so as to cover each well being studied.

For example, the beam emitted by the laser has a diameter of the order of 0.8 mm and a divergence of the order of 1 mrad. The diameter of this laser beam 44 at the output from the shaping assembly 46, magnified about three times by this assembly 46, is about 2.5 mm.

For information purposes only and in no way limitatively, a catadioptric objective with a magnification of 15×—aperture 0.3 to 0.5 and of the type marketed by the Coherent Company will be used.

Furthermore, for information purposes only and in no way limitatively, a cooled CCD camera will be used of the type marketed by the Soft Imaging System Company.

In cellular analysis, the trend is to use several markers (usually two or three) of different colours. For example, a fluorescein (excitation wave length 488 μm—emission wave length 520 μm) may be used with a rhodamine (excitation wave length 550 μm—emission wave length 580 μm) or the cy₃/cy₅ pair (cy₃:540/570 μm—cy₅: 630/670 μm).

In a device according to the invention, it is easy to mix two or three distinct laser beams and to use a multi-band filter which exists in two or three colours, with two or three shutters automatically switched by the software in order to activate the lasers emitting the beam in sequence, and to acquire two or three superposed images with different colours (or more if more lasers are used) for each well.

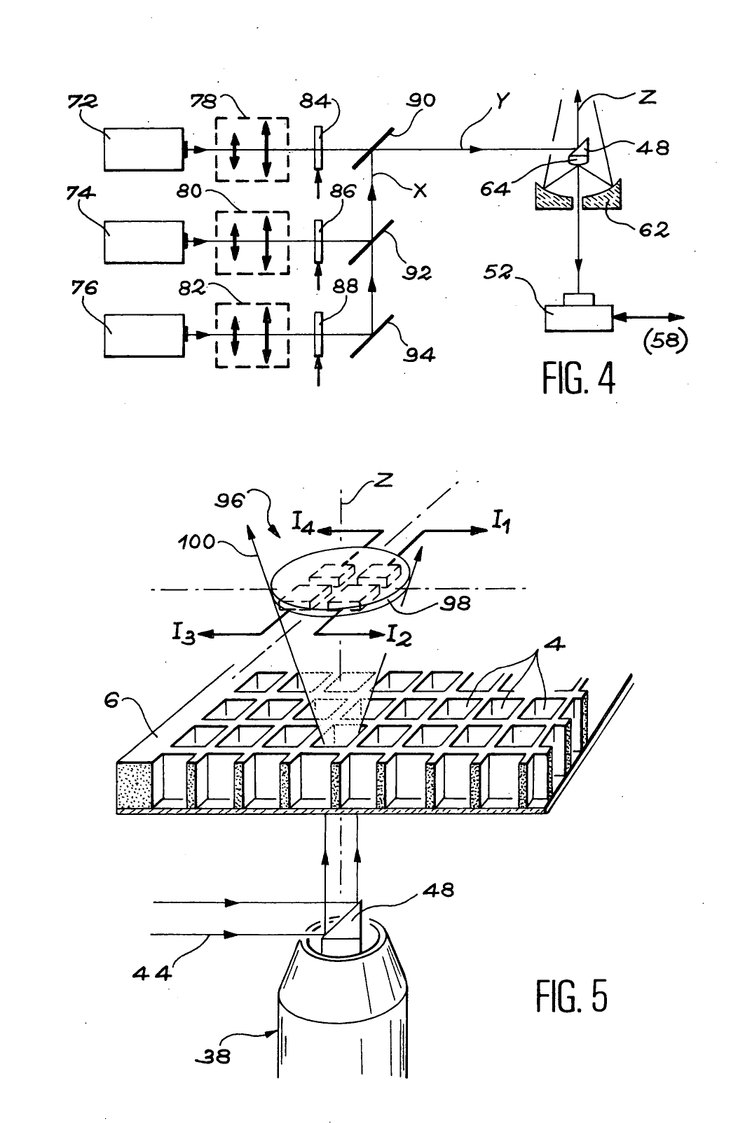

This is diagrammatically illustrated in FIG. 4 which schematically and partially shows a device conform with the invention comprising three lasers 72, 74 and 76 designed to emit excitation radiation for samples with different wave lengths (for example 488 μm, 532 μm and 550 μm).

Each of these lasers 72, 74 and 76 is followed in sequence by an optical assembly 78, 80 or 82 for shaping the beam output by this laser, a shutter 84, 86 or 88 (each shutter being controlled by the computer 58) and a mirror 90, 92 or 94. These mirrors are designed to obtain a laser beam directed along a Y axis perpendicular to the optical Z axis, and meeting the mirror 48, as a function of which shutter is activated.

More precisely, the mirror 94 associated with the laser 76 is a mirror at 45°, designed simply to reflect the beam corresponding to this laser along an X axis parallel to the optical Z axis.

The mirror 92 associated with the laser 74 is placed above the mirror 94 and is designed to transmit the beam reflected by this mirror 94 and to reflect the beam corresponding to the laser 74 along this X axis.

The mirror 90 associated with the laser 72 is designed to transmit the beam emitted by this laser along the Y axis and to reflect light from the mirror 92 so that the radiation thus reflected propagates along this Y axis (before being reflected on the mirror 48).

In the case of the device shown in FIG. 4, a buffer memory can then be provided in the computer 58 associated with the camera 52 to transfer an image of one colour to it while an image of another colour is being acquired.

Typically, the acquisition is done in a time between 200 ms and 500 ms. The transfer takes place in less than 500 ms.

As described above, a device according to the invention may use very high precision translation base plates which are therefore slow, the precision being of the order of 0.1 μm.

However, much less precise but much faster and less expensive base plates can be used with a precision of the order of 10 μm or more.

These much faster base plates can be used if automatic recognition means are used in the device to recognise a well to be studied when this well passes in front of the microscope objective 38.

One example of such a device is diagrammatically illustrated in FIG. 5. In this figure, automatic recognition means 96 are used for recognising a photodiode with four quadrants 98.

FIG. 5 shows the microtiter plate 6 that receives the laser excitation beam 44. Part of this beam emerges at the top end of the well being studied 4.

The shape of the laser beam 100 emerging from this upper end is approximately conical.

The photodiode with four quadrants 98 is placed above the microtiter plate 6 such that the optical Z axis of the microscope forms the axis of this photodiode with four quadrants 98, this photodiode thus intercepting the emerging beam 100.

The four electrical outputs from this photodiode with four quadrants are well balanced if the spot resulting from the emerging beam 100 is circular.

When the well is well positioned with respect to the optical Z axis, this spot is circular. Therefore, this gives a fixed value for immobilising translation base plates at the required position; if the laser spot is symmetrical, the intensities of the currents I₁, I₂, I₃ and I₄ output by the four-quadrant diode are equal.

Furthermore, the sum I of these four currents output from the photodiode represents the light intensity contained in this laser spot.

The sum of these four currents can be used either to regulate the laser that emits the beam 44, or as information to assure that this laser is operating correctly, or also for laser safety.

For example, it will be possible to design means of making it impossible to remove the protective cover from the device when the laser is in operation.

We will now consider processing of the images.

We will firstly consider an image processing application process.

This image processing may be done in real time or off-line.

If the processing is done in real time, the cellular analysis device successively chains the following tasks for each of the N wells in the microtiter plate:

(1) displacement of the microtiter plate onto well n (1≦n≦N),

(2) acquisition of the image of this well n,

(3) processing of the image of this well n.

For off-line processing, all that will be done are operations (1) and (2), in sequence for all wells. Once all images have been acquired for the microtiter plate considered, the image processing is done for each well.

We will now consider the nature of image processing.

The device according to this invention is used for cytometric analysis of various types of cells, for example neurones, keratinocytes, fibroblasts and tumoral cells. The purpose of image processing is to analyse the cells present in the samples and to extract interesting parameters from them.

The image processing may be more or less specific, depending on the application. In all cases, this image processing comprises an image segmentation step and a step in which parameters are calculated for each well.

Image segmentation identifies and separates bottom cells. The grey levels histogram may advantageously be used in this step to determine the binarisation threshold, with mathematical morphology algorithms. The following documents contain information about this subject:

[1] Digital image processing, Pratt William K, ed. Wiley, N.Y., 1978

[2] Segmentation Report, GDR134 Traitement du signal and des images (Signal and Image Processing), CNRS-GRECO, December 1991

[3] Image analysis and mathematical morphology, J. Serra, Academic Press, London 1982.

For information purposes only and in no way limitatively, software of the type marketed by the Soft Imaging Systems Company named Analysis, or the software marketed by the Khoral Research Company named Khoros Pro may be used.

For example, the parameters calculated for each well include cell size and shape parameters, the maximum fluorescence level for each cell and the number of cells. It is advantageous to use connectivity analysis algorithms in this step. Further information about this subject is given in documents [1] and [3] as mentioned above.

1. Device for observation by fluorescence of at least one sample (2) placed on a support (6), this device comprising:
means of illuminating the sample, these illumination means comprising at least one light source (42; 72, 74, 76),
an objective (38) for observation of the sample along an observation axis (Z), this observation objective being designed to form an image of the sample when the sample is illuminated,
means (32, 36) of relative displacement of the support (6) with respect to the observation objective (38), to place the sample on the observation axis, and
means (52) of acquisition of the image formed by the observation objective,
this device being characterised in that the observation objective is a catadioptric objective (38) and in that the illumination means (48) also comprise means (48) of reflecting light output from the source to the sample, these reflection means being placed between the observation objective (38) and the support (6).

2. Device according to claim 1, in which the catadioptric objective (38) comprises:
a parabolic mirror (62) designed to pick-up and then reflect light emitted by the sample when the sample receives light emitted by the source (42), and
an auxiliary mirror (64) that is placed at the focus of the parabolic mirror and designed to pick-up light reflected by this parabolic mirror and reflect this light to the acquisition means (52),
the means of reflecting light supplied by the source being placed between the auxiliary mirror (64) and the support (48).

3. Device according to claim 1, in which the illumination means also comprise means (46) of shaping the light emitted by the source.

4. Device according to claim 1, in which the light source is a laser (42; 72, 74, 76).

5. Device according to claim 1, in which the illumination means comprise a plurality of sources (72, 74, 76) capable of emitting different wave lengths of light, and means (84, 86, 88) of activating any one of these sources.

6. Device according to claim 1, in which the acquisition means include a charge-coupled device (CCD) camera (52).

7. Device according to claim 1, also comprising filter means (54) placed between the catadioptric objective (38) and the acquisition means (52) and designed to allow only light emitted by the sample to pass when said sample is illuminated.

8. Device according to claim 1, in which the support (6) is capable of receiving a plurality of samples (2) and said means of relative displacement (32, 36) are provided to place these samples on the observation axis (Z) one after the other, so that these samples can be observed sequentially.

9. Device according to claim 8, in which the support is a microtiter plate (6) comprising a plurality of wells (4) in which the samples (2) are respectively placed.

10. Device according to claim 9, also comprising means (96) of automatically positioning wells on the observation axis.

11. Device according to claim 10, in which automatic positioning means include a photodiode with four quadrants (98).

12. Device according to claim 1, also comprising means (58) of processing each image acquired by the acquisition means (52).

13. Device according to claim 9, also comprising means (58) of processing each image acquired by the acquisition means (52), this processing comprising an image segmentation step and a step for calculating parameters for each well.
